(19) United States
(12) Patent Application Publication
(10) Pub. No.: US 2020/0041617 A1
(43) Pub. Date: Feb. 6, 2020

(54) Optoelectronic Sensor and Method for Detecting an Object

(71) Applicant: SICK AG, Waldkirch (DE)

(72) Inventor: Hartmut GIMPEL, Waldkirch (DE)

(73) Assignee: SICK AG

(21) Appl. No.: 16/526,075

(22) Filed: Jul. 30, 2019

(30) Foreign Application Priority Data
Aug. 1, 2018 (DE) 102018118653.3

(51) Int. Cl. G01S 7/481; G01S 7/487

(52) U.S. Cl. CPC G01S 7/4816; G01S 7/4876

(57) ABSTRACT

An optoelectronic sensor (10) for detecting an object (20) in a monitoring region (18), the sensor (10) having a light transmitter (12) for transmitting transmitted light (16) of a wavelength range; a light receiver (32) for generating a received signal from the remitted light (22) remitted or reflected by the object (20), a reception optics (24) arranged in front of the light receiver (32), the reception optics (24) comprising at least a first optical element (26) for focusing the remitted light (22), a second optical element (28) for reducing the angle of incidence, and an optical filter (30) tuned to the wavelength range for suppressing interfering light; and an evaluation unit (34) which is configured to generate object information from the received signal, wherein the second optical element (28) comprises light scattering properties.

The invention relates to an optoelectronic sensor and a method for detecting an object in a monitoring region.

Many optoelectronic sensors operate with a scanning principle, where a light beam is transmitted into the monitoring region and the light beam reflected back from an object is received in order to electronically evaluate the received signal. The light time of flight is measured with a known phase or pulse method for determining the distance of a scanned object. This type of distance measurement is known as ToF (Time of Flight) or LIDAR (Light Detection and Ranging).

In order to extend the measuring region, the scanning beam can be moved like in a laser scanner. There, a light beam generated by a laser periodically scans the monitoring region by means of a deflection unit. In addition to the measured distance information, the angular position of the object is inferred from the angular position of the deflection unit, and thus the position of an object in the monitoring region is detected in two-dimensional polar coordinates. Laser scanners usually generate the scanning movement with a rotating mirror. However, it is also known that the entire measuring head including the light transmitters and light receivers rotates instead, as for example described in DE 197 57 849 B4.

Some conventional optoelectronic sensors use avalanche photodiodes (APD, Avalanche Photo Diode) in order to also detect low reception intensities. In an APD, the incident light triggers a controlled avalanche effect. This multiplies the charge carriers generated by incident photons and produces a photo current which is proportional to the light reception intensity, but much greater than that of a simple PIN diode. Even greater sensitivity is achieved with avalanche photodiodes that operate in the so-called Geiger mode (SPAD, Single Photon Avalanche Diode). Here, the avalanche photodiode is biased above the breakdown voltage so that even a single charge carrier released by a single photon can trigger an uncontrolled avalanche, which then recruits all available charge carriers due to the high field strength. The avalanche photodiode thus counts single events like the namesake Geiger counter. SPADs are not only highly sensitive, but also inexpensive. In addition, they can be integrated on a circuit board with little costs. They are available with rather large transverse dimensions of 1 mm and more, even larger in the case of image sensors with a large number of SPADs, and still have a high analog bandwidth.

In most cases, and in particular in distance measurement, the sensor must be able to distinguish between useful light, for example from its own or associated light transmitter, and ambient light or interference from other light sources. Depending on the application, for example in very bright environments, with poorly remitting targets or long measuring distances, this can be a very demanding task with extremely low useful light levels.

A well-known countermeasure is the narrowing of the field of view with an aperture that suppresses ambient light entering from the side. For example, it is known from EP 2 910 969 to position an aperture in the far focal plane of the reception lens in front of a light receiver with avalanche photodiodes in Geiger mode, and to arrange an optical funnel element between aperture and light receiver. This provides for a spatial ambient light suppression and an advantageous homogeneous light distribution on the light receiver. EP 3 339 887 A1 proposes an alternative for a mechanical aperture in the form of an electronic aperture that specifically adjusts the sensitivity of certain SPADs according to a given spatial pattern.

Ambient light can also be spectrally suppressed. For this purpose, an optical bandpass filter is used which is tuned to the wavelength of the transmitted light and which provides a significant improvement in the signal-to-noise ratio in case of broadband ambient light such as sunlight. The narrower the bandwidth of the bandpass filter without attenuating the useful light, the greater the advantage.

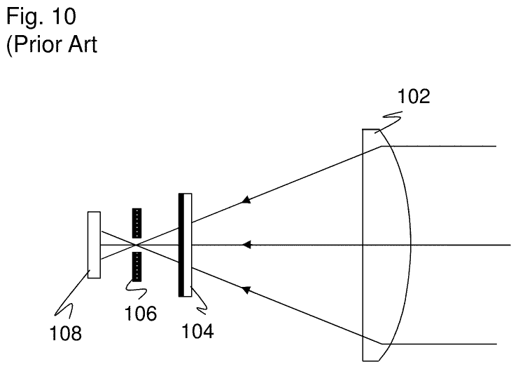

FIG. 10 shows a reception path according to the prior art, the reception path having a reception lens 102, an optical bandpass filter 104, an aperture 106 and a light receiver 108. The bandpass filter 104 is typically configured as a dielectric coating on a flat glass substrate. However, with that type of bandpass filter 104, the spectral filter edges depend on the angle of incidence. For example, using red light of about 660 nm, a commercially available bandpass filter of this type shifts its filter edges by approximately 55 nm when the angle of incidence increases from 0° to 40°.

It is conceivable to arrange the bandpass filter 104 near the reception lens 102 in the parallel beam path. Then, the relevant angle of incidence is small, and the filter edges can be very close to one another. However, that bandpass filter 104 requires large mechanical dimensions and is therefore very expensive. Alternatively, the bandpass filter 104 can be placed near the light receiver 108. The beam bundle is already very small in its geometry at that position, so that a small and inexpensive bandpass filter 104 can be used. However, the angle of incidence on the bandpass filter 104 becomes large. This is due to the large aperture ratio of the reception lens 102, which per its design focuses the largest possible reception area on the light receiver 108 within the shortest possible distance, so that the reception path is short and allows for small sensor designs. The beam divergence angles do reach ±30° or ±40°, so the above example of a shift of the filter edge by 55 nm is realistic.

In principle, an alternative would be to use colored glass instead of dielectric coatings for the bandpass filter 104. In that case, the spectral filter edges would be independent of the angle of incidence. However, such colored glasses containing heavy metals are to be avoided wherever possible for reasons of environmental compatibility.

DE 10 2015 224 715 A1 discloses a sensor element for distance measurement having a collecting lens configured as a long-pass filter in front of the light sensor. More specifically, this is achieved by colouring the collecting lens, without the above disadvantages being mentioned. In addition, the filter effect is worse than that of a bandpass filter because the longer-wave ambient light components can still pass.

U.S. Pat. No. 4,106,855 shows an optical system having a lens element comprising a spherical surface with an integrated narrow-band bandpass filter. The lens element itself and the other optical arrangements are far too complex to be used as reception optics in an optoelectronic sensor as herein discussed.

US 2017/0289524 A1 describes an optical system for detecting distance information. A common reception lens focuses the light onto a plurality of mechanical apertures, with a small collecting lens being arranged behind each of the apertures, the small collecting lens collimating the light which then impinges, through an optical bandpass filter, on respective pixels of a light receiver. The small collecting lenses reduce the angle of incidence so that the optical bandpass filter can operate in the desired wavelength range. However, they must have a relatively large image field because of the short distance to the pixel. This inevitably leads to a blurred image, because a single collecting lens cannot generate a sharp image over a large image field.

U.S. Pat. No. 4,184,749 discloses an arrangement of a spherical lens element and a concentric, arcuate lens element, which on its outside has a concentric, arcuate, narrow-band bandpass filter. The task of the arrangement is to receive light from a large field of view and scatter it in such a way that the rays radially leave the concentric lens element and thus vertically pass the arcuate bandpass filter. In order to manufacture the lens element with the bandpass filter, a macroscopic curved disc needs to be coated at prohibitive costs. Moreover, the arrangement is only intended for a large image plane and thus a large light receiver. The arrangement is not intended for a conventional light receiver or pixel of an optoelectronic sensor as discussed herein, and could not be used for this purpose.

It is therefore an object of the invention to improve ambient light suppression with an optical filter.

This object is satisfied by an optoelectronic sensor, in particular a photoelectric proximity switch, for detecting an object in a monitoring region, the sensor having a light transmitter for transmitting transmitted light of a wavelength range; a light receiver for generating a received signal from the remitted light remitted or reflected by the object, a reception optics arranged in front of the light receiver, the reception optics comprising at least a first optical element for focusing the remitted light, a second optical element for reducing the angle of incidence, and an optical filter tuned to the wavelength range for suppressing interfering light; and an evaluation unit which is configured to generate object information from the received signal, wherein the second optical element comprises light scattering properties.

The object is also satisfied by a method for detecting an object in a monitoring region, wherein transmitted light of a wavelength range is transmitted; is received again as remitted light by a reception optics after reflection or remission by the object and is converted into a received signal in order to generate object information from the received signal, wherein the reception optics focus the remitted light with a first optical element, reduce the angle of incidence of the remitted light with a second optical element, and suppress interfering light with an optical filter tuned to the wavelength range, wherein the second optical element reduces the angle of incidence by means of light scattering properties.

A light transmitter generates transmitted light in a specific, preferably narrow wavelength range. The transmitted light is received as remitted light after it has at least partially been reflected by an object in the monitoring region. The corresponding received signal of a light receiver is evaluated in order to obtain optically detectable information about the object, such as binary presence information, a position, or a color.

In the reception path of the remitted light in front of the light receiver, reception optics are arranged, having a first optical element for focusing, for example a main or reception lens, possibly also an objective with several lenses, or a reflective arrangement. A second optical element limits the angle of incidence, i.e. it aligns the incident rays so that they are more parallel to one another. An optical filter is tuned to the wavelength range of the light transmitter in order to allow only the remitted light to pass and to suppress ambient light outside the filter's spectrum. The second optical element ensures that remitted light with a limited beam angle divergence reaches the optical filter. First optical element, second optical element and optical filter are preferably arranged in this order in the direction of incidence of the remitted light.

The invention starts from the basic idea of configuring the second optical element so that it scatters light, in the sense of widening the beam. In the case of a lens as a second optical element, this is a scattering or concave lens with a negative and preferably short focal length. However, in the following, preferred embodiments are described wherein the second optical element is not a lens, but is a non-imaging optical element. In particular, the light scattering properties can be defined in that the second optical element is thicker at the edge than in the center, as is the case with a concave lens.

When looking at the light receiver through the second optical element, it appears smaller than it is due to the second optical element's light scattering properties, for example the virtual image is only half the size or even smaller. The term virtual image is used here in analogy, although the term actually is based on a concave lens, and the second optical element preferably is non-imaging and thus not a concave lens. The light rays of the main reception lens, usually a large lens, are arranged in a direction towards this significantly reduced virtual image, so the field of view is only as large as that of an imaginary smaller light receiver. At the same time, the light rays, which are still convergent after the focusing first optical element, approach the light receiver at a significantly reduced angle after the second optical element.

The invention has the advantage that the optical filter can be tuned more closely to the wavelength range of the light transmitter, thus achieving significantly better ambient light suppression. The angle dependence of the optical filter is reduced or removed due to the properties of the second optical element and its stronger limitation of the angle of incidence. The second optical element acts as a virtual aperture, more precisely a virtual field diaphragm, and an additional mechanical aperture component is no longer required. Thus the ambient light is reduced spatially and spectrally. This improves the signal-to-noise ratio and ultimately the performance of the sensor, for example by increasing the range or by providing more accurate measured values.

The light receiver preferably comprises a plurality of light receiving elements, in particular avalanche photodiode elements in Geiger mode or SPADs. Throughout this specification, the terms preferred or preferably refer to an advantageous, but completely optional feature. The plurality of light receiving elements can be implemented as separate elements or as integrated pixels and can be used both for spatial resolution or a combined evaluation. In particular with SPADs, a statistical common evaluation is advantageous, which commonly evaluates or adds up the received signals of several SPADs.

The second optical element preferably has non-imaging properties. This has already been mentioned above, the second optical element in this preferred embodiment is not a conventional scattering lens, but is configured to be non-imaging. Because of a possible axicon-like shape, such a second optical element can be called a scattering axicon lens. The second optical element according to this preferred embodiment merely has the task of generating a sharp image of the edges of the light receiver, more precisely of its light-sensitive surface or of the respective pixels. Inside, between these edges, there is a non-imaging light redistribution. By accepting such distortions and blurring, it is possible to manage with only a single second optical element in the reception path. For a sharp imaging, on the other hand, an objective-like multiple arrangement would be required.

A contour line along a diameter through the second optical element preferably has at least one sharp change of slope, in particular at the center. The second optical element thus clearly differs from a concave lens, where a corresponding contour line has a smooth and slowly varying slope. The extreme case of a sharp change in the sense of a non-differentiable point is not necessarily required for the second optical element, but there is a very sudden and considerable change in the slope, leading to a pronounced edge or tip. In a preferred configuration where the second optical element has rotational symmetry, the sharp change of slope may be located at the center.

The second optical element preferably has a shape of a negative cone. A cone is an exemplary geometry with a non-differentiable point at its tip. However, some rounding for simplified production is tolerated. The cone is called negative because the second optical element itself is not conical, but has a corresponding recess shaped like a cone. Thus the second optical element is the complement of a cone, which for example is cut out of a cylinder with the same base area. A radial curvature of the cone surface leads to a double-bellied shape which is also conceivable.

The second optical element, in a parameterization of the cone with a radius of curvature 1/c and a cone constant k, preferably has a cone constant k<−2. This parameterization will be described in more detail with reference to the Figures. For a spherical lens, on the other hand, the relation k=0 would hold, and for an aspherical lens |k|<2.

The second optical element, in a parameterization as an odd asphere, preferably has a non-zero linear component. This parameterization will also be discussed in more detail later. For an odd asphere, the z contour is developed as a polynomial for the radius r, and the odd polynomial terms are used, in contrast to an even asphere. The embodiment with a non-zero linear component requires that the coefficient β₁ of the linear component r¹=r for the second optical element does not equal zero. This does not only mean a marginal non-zero coefficient very close to zero in the sense of tolerances or the like, but a real, significant contribution of β₁ actually influencing the optical properties of the second optical element.

The second optical element preferably is configured as a microelement. Accordingly, only a very small optical filter is required. A microelement is particularly suitable for the case of a plurality of light receiving elements or pixels, each of which then preferably is assigned a second optical element.

A distance between the light receiver and the second optical element preferably is only in the order of magnitude of an extension of the light sensitive area of the light receiver. This means that, for an edge length d of the photosensitive surface of the light receiver, the second optical element does not exceed the distance n*d with n≤10 or even n≤5 or n≤1. The case n≤1 implies that the second optical element is closer to an edge of the light receiver than this edge to the light receiver's opposite edge. The second optical element is thus positioned very close to the light receiver. In the case of a plurality of light receiving elements, the distance preferably is not in the order of magnitude of the light receiver, but of the individual light receiving element. Preferably the second optical element is micromechanically connected to the light receiver and thus correctly adjusted.

The optical filter preferably is a bandpass filter. It therefore cuts off ambient light at both small and large wavelengths. The bandpass filter may have a particularly narrow bandwidth according to the invention, for example have a bandwidth of at most 50 nm up to at most 80 nm or 100 nm. There is no need for a tolerance wavelength range for obliquely incident light, or the tolerance at least can be considerably smaller than in the conventional case.

The optical filter preferably is arranged on a rear side of the second optical element or on the light receiver, in particular as a coating. This allows the optical filter to be manufactured in a very cost-effective and space-saving way. Due to the properties of the second optical element, the effects of an angle dependence of an optical filter with dielectric layers are greatly reduced, and therefore no angle-independent filter such as colored glass with problematic heavy metals is required, although this is technically conceivable, even in combination with a coating. The rear side of the second optical element is preferably flat, while some curvature for supporting the optical effect of the front side is still conceivable and still permits a coating. As an alternative or in addition to a coating on the rear side of the second optical element, a coating on the light receiver or on its light receiving elements or pixels is possible.

The evaluation unit preferably is configured to determine a distance of the object from a light time of flight between transmission of the transmitted light and reception of the remitted light. The sensor thus is a distance-measuring sensor. In particular for long ranges, strong ambient light and/or poorly remitting, dark objects, the useful light proportion often is very low, so that a time of flight method benefits greatly from improved ambient light suppression.

The sensor preferably is configured as a laser scanner having a movable deflection unit for periodically deflecting the transmitted light in the monitoring region. This greatly enlarges the monitoring region as compared to a one-dimensional sensor, namely to a scanning plane with an angular range of up to 360° and, with additional deflection in elevation and/or use of several scanning beams mutually offset in elevation, even to a three-dimensional spatial area. The laser scanner preferably uses a time of flight method for distance measurement and thus, taking into account the respective angles at which the transmitted light is transmitted, generates 3D measuring points within the scanning plane or even in 3D space.

The method according to the invention can be modified in a similar manner and shows similar advantages. Further advantageous features are described in an exemplary, but non-limiting manner in the dependent claims following the independent claims.

The invention will be explained in the following also with respect to further advantages and features with reference to exemplary embodiments and the enclosed drawing. The Figures of the drawing show in:

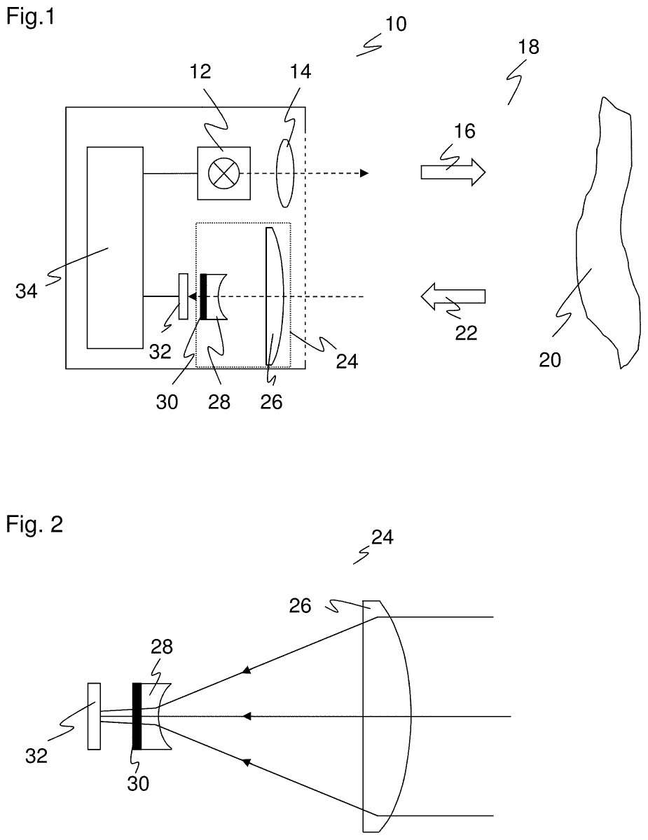

FIG. 1 a schematic representation of an optoelectronic sensor;

FIG. 2 a schematic representation of the reception path of an optical sensor;

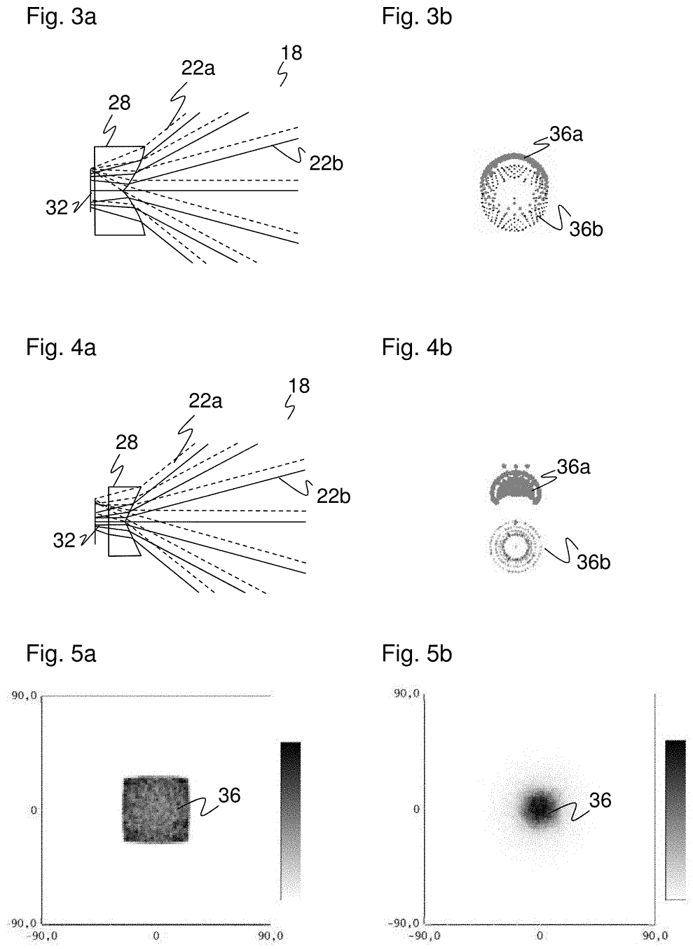

FIG. 3a an exemplary beam path at a double-belly scattering optical element in the reception path in front of a light receiver;

FIG. 3b a representation of the light spot on the light receiver for the beam path according to FIG. 3a;

FIG. 4a an exemplary beam pattern similar to FIG. 3a, here at a conical scattering optical element in the reception path in front of a light receiver;

FIG. 4b a representation of the light spot on the light receiver to the beam path according to FIG. 4a;

FIG. 5a an angular distribution of the received light on an optical filter without scattering optical element, as a reference;

FIG. 5b an improved angular distribution of the received light on an optical filter with a scattering optical element;

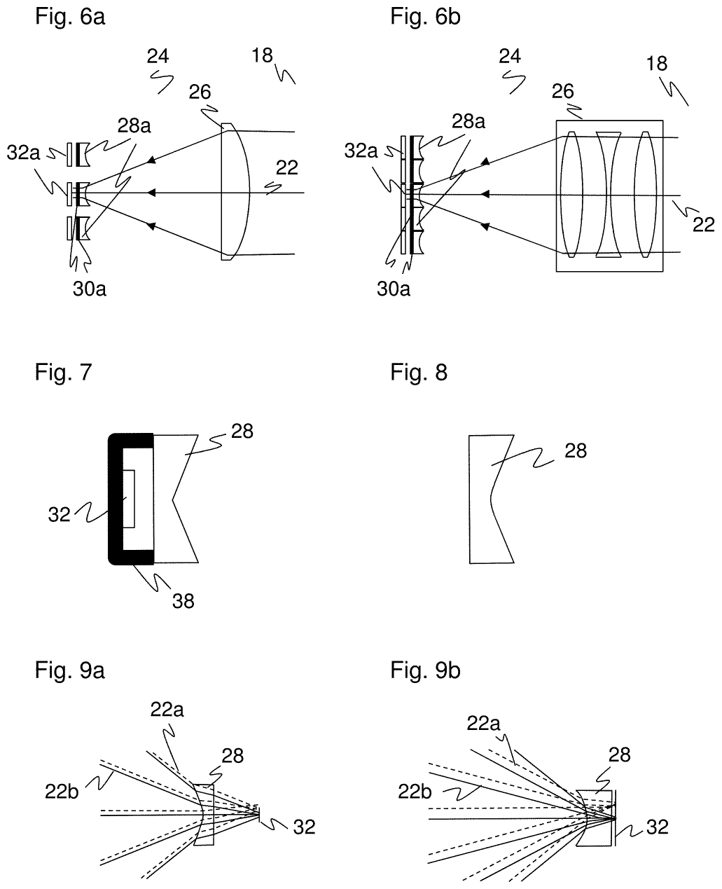

FIG. 6a a multiple arrangement of discrete light receiving elements with respective scattering optical elements;

FIG. 6b a multiple arrangement of integrated light receiving elements with respective scattering optical elements;

FIG. 7 an arrangement of a scattering optical element micromechanically connected to the light receiver;

FIG. 8 a representation of a scattering optical element with rounded edges;

FIG. 9a an exemplary beam path on a scattering optical element in a considerable distance from the light receiver;

FIG. 9b an exemplary beam path on a scattering optical element close to the light receiver; and

FIG. 10 a schematic representation of the reception path of an optical sensor according to the prior art.

FIG. 1 shows a schematic sectional view of an optoelectronic sensor 10. A light transmitter 12, for example a laser or an LED, transmits transmitted light 16 into a monitoring region 18 via transmission optics 14. The light transmitter 12 preferably has a laser light source, in particular a semiconductor laser in the form of a VCSEL laser or edge emitter, but also another laser such as a fiber laser. This allows a very narrow wavelength range of the transmitted light 16. The light wavelengths used are typically between 200 nm and 2000 nm, in particular at 660 nm, 850 nm, 900 nm and 1550 nm.

If the transmitted light 16 impinges on an object 20 in the monitoring region 18, part of the light returns to the sensor 10 as remitted light 22, where it is guided onto a light receiver 32 by reception optics 24 having a reception lens 26, a scattering optical element 28 and an optical filter 30. The configuration and function of the reception optics 24 will be explained later with reference to FIGS. 2 to 9. The light receiver 32 for example is a PIN diode, an APD (avalanche photodiode), a single photon APD (SPAD, avalanche photodiode in Geiger mode) or a multiple arrangement thereof.

An evaluation unit 34, for example having one or more digital components like a microprocessor, an FPGA (Field-Programmable Gate Array) or an ASIC (ApplicationSpecific Integrated Circuit), controls the light transmitter 12 and evaluates the received signal of the light receiver 32 in order to obtain optically detectable information of the object 20, for example a binary presence detection, an object position or a colour. Preferably, the evaluation unit 34 determines a distance of the object 20 by means of triangulation or a time of flight method. The light time of flight method can be a single pulse or multiple pulse method, but also a phase method and is known per se.

The basic configuration of the sensor 10 according to FIG. 1 is to be understood as an example only. Other arrangements, such as a coaxial instead of a biaxial configuration, and sensor types other than a one-dimensional sensor 10 are conceivable, in particular a laser scanner.

FIG. 2 again shows the reception path and the reception optics 24 of FIG. 1 in an enlarged view. The reception lens 26 is a convex or collecting lens with as large an aperture as possible and with a short focal length, in order to enable a compact design of the sensor 10. Instead of a single lens, multiple lenses or an objective as well as an alternative reflective structure are also conceivable.

The scattering optical element 28 of this embodiment is configured as a scattering lens having a negative focal length, preferably as a microlens. The scattering optical element 28 can be made of glass or plastic, because the thermal expansion and refractive index change of plastic is no longer important when placed in the immediate vicinity of the light receiver 32.

The plane or alternatively at least slightly curved rear side of the scattering optical element 28 comprises the optical filter 30 in the form of a dielectric bandpass coating. Alternatively, an independent filter element or a coating on the light receiver 32 would be conceivable. For a light transmitter 12 with laser light source and narrow optical bandwidth, the optical filter 30 can be narrowed to a filter bandwidth of for example 50 nm or 80 nm at a central wavelength corresponding to the wavelength of the laser.

The effect of the scattering optical element 28 is a reduced virtual intermediate image of the light receiver 32. This reduced virtual intermediate image is imaged into the monitoring region 18 by the reception lens 26, and thus an advantageously reduced field of view (FOV) is achieved. In addition, the scattering optical element 28 reduces the angle of incidence on the light receiver 32. Therefore, only smaller angles of incidence occur on the rear side of the scattering optical element 28. Therefore, no or at least only a lesser angle-dependent shift of the passband of the optical filter 30 needs to be taken into account, and thus a narrower passband may be used.

The scattering optical element 28 should be arranged as close as possible to the light receiver 32, so that it can be small itself and only have a small rear side to be coated for the optical filter 30. This proximity results in the requirement to sharply image a relatively large image field. In other words, from the position of the scattering optical element 28, the two edges of the light receiver appear at a large angular distance, with in particular a light receiver configured as a SPAD easily reaching an edge length of 0.5 mm or even 1 mm. A single lens cannot manage a sharp imaging of a large image field, this would require a plurality of lenses or an objective, but that should be avoided due to cost restrictions. As a result, there are pronounced imaging errors, mainly at the edge of the image, i.e. the edges of the light receiver in particular are very blurred. The attempt to design a classic lens so that the edges are sharp while accepting internal blurring improves the situation only slightly.

Therefore, it is possible to use a classic scattering lens as the scattering optical element 28 as shown in FIG. 2. Then, the blurred image of the edges of the light receiver 32 is simply tolerated. However, as compared to the even more advantageous embodiments to be described in the following, useful light is lost and more ambient light is detected at the same time.

Even better results are achieved when a non-imaging, axicon-like lens is used instead as the scattering optical element. There is no longer any attempt to sharply image the entire image field, i.e. the entire area of the light receiver, because a single lens cannot do this satisfactorily. In other words, no sharp image is attempted any more in the sense that the dot images become very small overall. Rather, the goal is that the point image for all field points, or actually only for the outermost field point, remains entirely on the intended detection surface of the light receiver 32. In contrast to a classic sharp image, the substructure is thus lost, but the entire amount of light is still collected and directed to the light receiver 32 with as little loss as possible. The relevant amount of light is virtually caged within the limits formed by the edges of the light receiver 32, so that, insofar that is possible, the light receiver 32 does not lose any light energy of the remitted light 22. The image is blurred inside this surrounding edge. However, this behaviour, which at first glance appears unfavourable, is deliberately accepted in order to achieve the desired virtual aperture effect, i.e. to direct only useful light and as much useful light as possible to the light receiver 32 within the edge.

The configuration and behavior of various non-imaging scattering optical elements will now be described in more detail. FIG. 3a shows the beam path of the remitted light 22a-b in an enlarged view only in the vicinity of the scattering optical element 28, wherein the optical filter 30 at its rear side is not shown here and in some other Figures for the sake of clarity. Two beams of remitted light 22a-b with different field angles are represented by a solid line and a dotted line, respectively. FIG. 3b shows the corresponding received light spots 36a-b in the image plane on the light receiver 32.

The scattering optical element 28 has a front side with a contour similar to a negative or scattering axicon. An intuitive description of a negative or scattering contour is that the edge area is thicker than the center, as in a classic concave scattering lens. It becomes non-imaging, for example, by a part or position with a sharp gradient change or change in slope, in the extreme case a non-differentiable gradient change. The example in FIG. 3a shows a double-bellied contour with a kind of tip in the middle.

As a numerical example for a typical application case, for the beam path of the remitted light 22a-b in FIG. 3a and the received light spots 36a-b in FIG. 3b a focal length of the reception lens 26 of f=50 mm and a diameter of Ø=80 mm are assumed. This results in an angle of the converging light beams of the remitted light 22a-b after the reception lens 26 of arctan(40/50)≈38.7°. The reception lens 26 is optimized for imaging a single axial object point in infinity, so that the received light spot for collimated light along the optical axis would be small within the limits of diffraction. The remitted light 22a shown with a dotted line corresponds to a field angle of 0.23°, the remitted light 22b shown with a solid line to a field angle of 0°. A field angle of ±0.23°, on the other hand, corresponds to a received light spot of size 0.4 mm, for example on a 0.8 mm to 1 mm SPAD of the light receiver 32.

The shape of the scattering optical element 28 is configured so that a received light spot of size 0.8 mm is created on the SPAD instead, i.e. the scattering optical element 28 has an image scale of two. In a parameterization called odd asphere to be explained in detail below, it has the parameters β₁=−0,9 and β₂=0,5, a centre thickness of 0.5 mm and a distance of approximately 0.14 mm between its rear face and the SPAD. The distance between the scattering optical element 28 and the reception lens 26 in turn is chosen so that the beams for the opposite edges of the SPAD have not yet completely separated in this image section. This can be seen by the fact that some beams of the remitted light 22a shown in dashed line still pass through the lower half of the scattering optical element 28.

In FIG. 3b it can be seen that also the beams at the edge of the field which are aimed at an edge of the SPAD or light receiver 32, respectively, are deflected in such a way that they remain within the target range of ±0.4 mm. In this sense, the scattering optical element 28 still generates a sharp image, although this dot image has by far no small extension. The dot image for a field angle of 0° is even larger, so the center is even more blurred. However, the imaging properties with the large dot images only look bad at first glance. The scattering optical element 28 is ideally suited to collect the remitted light 22a-b on the light receiver 32 and to thereby illuminate an area of double transverse dimension on the light receiver 32, without directing light beams beyond the desired edge here at ±0.4 mm, where they could no longer be detected.

FIGS. 4a and 4b show another example now with a cone-shaped scattering optical element 28, without again giving specific exemplary numbers. In cross-section, this scattering optical element 28 looks like two prisms, in spatial terms it is typically a circular cylinder or similar body with a conical recess. The image of the edge in the received light spot 36a is no longer as sharply limited to the edge. The enlarged light spot on the light receiver 32 thus is slightly blurred at the edge. Nevertheless, this embodiment of the scattering optical element 28 is still very useful and in particular more usable than a classic scattering lens. Reference is made to FIGS. 3a and 3b for additional explanation and conclusions.

This form of the scattering optical element 28 can be represented in a parameterization for z as arrow height depending on the distance r from the lens center with radius of curvature 1/c and cone constant k as

$$z = \frac{{cr}^{2}}{1 + \sqrt{1 - ( 1 + k ) {c}^{2} {r}^{2}}} , ,$$

where for a conical shape k<−2. In contrast, for a spherical lens, k=0, and for an asphere usually |k|<2. The form is thus mathematically a hyperbola.

The same can be formulated for k in the extended parameterization of the lens shape as an even asphere:

$$z = \frac{{cr}^{2}}{1 + \sqrt{1 - ( 1 + k ) {c}^{2} {r}^{2}}} + {α}_{1} {r}^{2} + {α}_{2} {r}^{4} + … .$$

In a parameterization of the lens shape as an odd asphere

$$z = \frac{{cr}^{2}}{1 + \sqrt{1 - ( 1 + k ) {c}^{2} {r}^{2}}} + {β}_{1} {r}^{1} + {β}_{2} {r}^{2} + {β}_{3} {r}^{3} + {β}_{4} {r}^{4} + … ,$$

instead of k<−2, which would again be possible, also the parameter k=0 and a value for the coefficient β₁ significantly different from zero can be selected. For spherical lenses and imaging aspheres, β₁=0 would hold. In addition, in at least some preferred embodiments, β₂ also differs significantly from zero and preferably is positive.

In more general terms, it can be said that the scattering optical element 28 for a large part of its used surface of at least 50%, 75% or even 80% or 90% is shaped so that this extrapolated surface runs towards a sharp-edged tip in the middle. The scattering optical element 28 is kind of bent in its center, and thus additional degrees of freedom result as compared to a classic scattering lens, which make it possible to consider rays separately and let them direct towards different edges of the light receiver 32. Thus a sharp image of the entire edge is achieved with only one optical element, which would not be possible with a classic scattering or collecting lens. The scattering optical element 28 is preferably rotationally symmetrical, but some deviation from the symmetry is possible without severely impairing the function.

FIGS. 5a-b once again illustrate the effect of the scattering optical element 28. FIG. 5a shows the angular distribution without the scattering optical element 28 and FIG. 5b with a scattering optical element 28 as introduced with reference to FIGS. 3a-b and 4a-b. It can be clearly seen that the distribution of the angle of incidence in FIG. 5b, with the scattering optical element 28, assumes significantly smaller values. Therefore, the optical filter 30 can be chosen much narrower in the case of FIG. 5b, without losing much light intensity, because the actual angles of incidence are clearly limited. The angle of incidence range is roughly halved, so that the optical filter 30 for example only has to cope with ±20° instead of ±40°.

FIG. 6a shows a further embodiment of the reception path. It has already been mentioned above that the light receiver 32 can also have a plurality of light receiving elements 32a. In FIG. 6a, this is an arrangement of a plurality of separate or discrete light receiving elements 32a, which can for example be SPADs, photodiodes or APDs. In this embodiment, the reception optics 24 preferably still comprise only one common reception lens 26, but a separate scattering optical element 28a for each light receiving element 32a.

FIG. 6b shows an alternative embodiment with a matrix arrangement of light receiving elements 32a or pixels integrated on the light receiver 32, for example an image sensor with a line, matrix or other arrangement. This matrix arrangement is assigned a matching grid of a plurality of scattering optical elements 28a, which generate several virtual apertures. In addition, the reception lens 26 has been replaced by a multi-lens objective, which has already been described as a possible alternative for all embodiments.

FIG. 7 shows an exemplary configuration of the scattering optical element 28 in micromechanical connection with the light receiver 32. For example, the scattering optical element 28 replaces a cover glass of an electronics housing 38 for the light receiver 32. The micromechanical connection then also automatically guarantees the required exact position accuracy between the scattering optical element 28 and the light receiver 32.

FIG. 8 shows another embodiment of the scattering optical element 28. In contrast to the previously shown conical or wedge-shaped recess, the tip or strong change of gradient at the center and if necessary also the outer edges are rounded. This facilitates the manufacturing of the scattering optical element 28. The area portion of the central rounding should not become too large, should for example be limited to 20%, in order not to seriously impair the function and to maintain a clearly different shape as compared to a a classic, imaging scattering lens.

FIGS. 9a-b illustrate why it is advantageous to position the scattering optical element 28 in close proximity to the light receiver 32. For example, the distance from the axicon apex to the light-sensitive area of the light receiver is at most five times the dimension of the light-sensitive area, or the dimension of a single light-receiving element 32a or pixel, respectively.

If the distance is too large, as in FIG. 9a, the light beams of the remitted light 22a for the upper edge of the light receiver 32 and the light beams of the remitted light 22b for the lower edge of the light receiver 32 still pass through the same surface element of the scattering optical element 28, which thus does actually not perform its function. The light rays are without selection deflected in the same direction. This shifts the angle of incidence range, but does not make it narrower. In this context, the dotted and solid lines of the remitted light 22a-b are to be understood in analogy to FIGS. 3a and 4a.

By arranging the scattering optical element 28 in close proximity to the light receiver as shown in FIG. 9b, the desired effect is achieved, and the angle of incidence range is significantly reduced.

1. An optoelectronic sensor (10) for detecting an object (20) in a monitoring region (18), the sensor (10) having
a light transmitter (12) for transmitting transmitted light (16) of a wavelength range;
a light receiver (32) for generating a received signal from the remitted light (22) remitted or reflected by the object (20),
a reception optics (24) arranged in front of the light receiver (32), the reception optics (24) comprising at least a first optical element (26) for focusing the remitted light (22), a second optical element (28) for reducing the angle of incidence, and an optical filter (30) tuned to the wavelength range for suppressing interfering light;
and an evaluation unit (34) which is configured to generate object information from the received signal,
wherein the second optical element (28) comprises light scattering properties.

2. The sensor (10) according to claim 1,
wherein the light receiver (32) comprises a plurality of light receiving elements (32a).

3. The sensor (10) according to claim 2,
wherein the light receiving elements (32a) comprise avalanche photodiode elements in Geiger mode.

4. Sensor (10) according to claim 1,
wherein the second optical element (28) has non-imaging properties.

5. Sensor (10) according to claim 4,
wherein a contour line along a diameter through the second optical element (28) has at least one sharp change of slope.

6. The sensor (10) according to claim 5,
wherein the change of slope is located at the center.

7. The sensor (10) according to claim 1,
wherein the second optical element (28) has a shape of a negative cone.

8. The sensor (10) according to claim 1,
wherein the second optical element (28), in a parameterization of the cone with a radius of curvature and a cone constant, has a cone constant less than −2.

9. The sensor (10) according to claim 1,
wherein the second optical element (28), in a parameterization as an odd asphere, has a non-zero linear component.

10. The sensor (10) according to claim 1,
wherein the second optical element (28) is configured as a microelement.

11. The sensor (10) according to one of the previous claims,
wherein a distance between the light receiver (32) and the second optical element (28) is only in the order of magnitude of an extension of the light sensitive area of the light receiver (32).

12. The sensor (10) according to one of the previous claims,
wherein the optical filter (30) is a bandpass filter.

13. The sensor (10) according to claim 1,
wherein the optical filter (30) is arranged on a rear side of the second optical element (28) or on the light receiver (32).

14. The sensor (10) according to claim 13,
wherein the optical filter (30) is configured as a coating.

15. The sensor (10) according to claim 1,
wherein the evaluation unit (34) is configured to determine a distance of the object (20) from a light time of flight between transmission of the transmitted light (16) and reception of the remitted light (22).

16. The sensor (10) according to claim 1,
the sensor (10) being configured as a laser scanner and having a movable deflection unit for periodically deflecting the transmitted light (16) in the monitoring region (18).

17. A method for detecting an object (20) in a monitoring region (18), wherein transmitted light (16) of a wavelength range is transmitted;
is received again as remitted light (22) by a reception optics (24) after reflection or remission by the object (20)
and is converted into a received signal in order to generate object information from the received signal,
wherein the reception optics (24) focus the remitted light (22) with a first optical element (26), reduce the angle of incidence of the remitted light (22) with a second optical element (28), and suppress interfering light with an optical filter (30) tuned to the wavelength range,
wherein the second optical element (28) reduces the angle of incidence by means of light scattering properties.
